(19) United States
(12) Patent Application Publication
(10) Pub. No.: US 2009/0276796 A1
(43) Pub. Date: Nov. 5, 2009

(54) DISK CLAMP AND DISK DEVICE

(75) Inventor: Tetsuo Kuribayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/356,670

(22) Filed: Jan. 21, 2009

(30) Foreign Application Priority Data
May 2, 2008 (JP) 2008-120676

(51) Int. Cl. G11B 17/04

(52) U.S. Cl. 720/604

(57) ABSTRACT

A disk clamp includes a flat plate. A receiving hole penetrates through the flat plate. Through holes penetrate through the flat plate on an imaginary circle defined around the longitudinal center axis of the receiving hole. Depressions are formed on the front surface of the flat plate at positions between the through holes. The disk clamp is mounted on a rotor of the spindle motor, for example. A screw is received in a screw bore formed in the flat plate when the disk clamp is mounted on the rotor. The screw is screwed into the rotor. A disk medium is mounted on the spindle motor. In the process of screwing, a jig is inserted in the through hole. The jig is received in a bottomed hole formed in the rotor. The jig serves to restrict relative rotation between the disk clamp and the rotor.

### CROSS-REFERENCE TO RELATED APPLICATION

This application is based upon and claims the benefit of priority from the prior Japanese Patent Application No. 2008-120676 filed on May 2, 2008, the entire contents of which are incorporated herein by reference.

### FIELD

The embodiments discussed herein are related to a disk clamp incorporated in a disk device such as a hard disk drive, HDD, for example.

### BACKGROUND

A spindle motor is incorporated in a hard disk drive, for example. Magnetic recording disks are mounted on a spindle hub of the spindle motor. The magnetic recording disks are firmly held between a disk clamp and a flange of the spindle hub. The disk clamp includes a disk-shaped flat plate. A receiving hole is formed in the flat plate at the center of the flat plate. A screw is inserted in the receiving hole. The screw is screwed into a screw bore of the spindle hub. In this manner, an urging force is applied to the magnetic recording disks from the disk clamp toward the flange.

Four through holes are formed in the flat plate of the disk clamp, for example. The through holes have the centers arranged at equal intervals on a predetermined imaginary circle aligned with the longitudinal center axis of the receiving hole, for example. Four depressions are formed in the spindle hub at positions corresponding to the positions of the through holes, respectively. Pins are inserted in two of the through holes on a diameter of the disk clamp in the process of attachment of the disk clamp, for example. Relative rotation is in this manner restricted between the disk clamp and the spindle hub. Simultaneously, a screw is screwed into the screw bore.

The rigidity of the flat plate is reduced in the disk clamp of this type because of the through holes. The rigidity of the flat plate is maintained at areas between adjacent ones of the through holes. This results in unevenness of an urging force around the longitudinal center axis of the receiving hole. Such unevenness of an urging force causes undulation in the flat plate along the aforementioned imaginary circle. Such undulation causes a corresponding undulation of the magnetic recording disk. Undulation of the magnetic recording disk has a negative influence on the read/write operation of a head element. In particular, the magnetic recording disk has to be prevented from establishment of undulation so as to improve the recording density.

### SUMMARY

According to a first aspect of the invention, a disk clamp includes: a flat plate; a receiving hole penetrating through the flat plate from the front surface of the flat plate to the back surface of the flat plate so as to receive a screw therein; through holes penetrating through the flat plate from the front surface of the flat plate to the back surface of the flat plate on an imaginary circle defined around the longitudinal center axis of the receiving hole; and depressions formed on the front surface of the flat plate at positions between the through holes.

The disk clamp is mounted on a rotor of the spindle motor, for example. A screw is received in a screw bore formed in the flat plate when the disk clamp is mounted on the rotor. The screw is screwed into the rotor. In this manner, a disk medium is mounted on the spindle motor. In the process of screwing, a jig is inserted in the through hole, for example. The jig is received in a bottomed hole formed in the rotor, for example. The jig serves to restrict relative rotation between the disk clamp and the rotor. The screw is thus readily screwed into the rotor.

The disk clamp includes the flat plate. The through holes are formed on the imaginary circle defined around the longitudinal center axis of the receiving hole. The through holes penetrate through the flat plate from the front surface of the flat plate to the back surface of the flat plate. The rigidity of the flat plate is reduced at the areas including the through holes. Simultaneously, the depressions are formed on the front surface of the flat plate at the positions between the adjacent ones of the through holes. The thickness of the flat plate is reduced at the areas including the depressions. The rigidity of the flat plate is thus reduced at the areas including the depressions. In this manner, unevenness of the rigidity is eliminated around the longitudinal center axis of the receiving hole. Undulation is reduced in the flat plate.

The disk clamp is incorporated in a disk device, for example. The disk device comprises: a spindle motor; a disk medium mounted on the spindle motor at a position aligned with the rotation axis of the spindle motor; a disk clamp clamping the disk medium against the spindle motor; a receiving hole penetrating through a flat plate of the disk clamp from the front surface of the flat plate to the back surface of the flat plate, the receiving hole aligned with the rotation axis of the spindle motor; through holes penetrating through the flat plate of the disk clamp from the front surface of the flat plate to the back surface of the flat plate on an imaginary circle defined around the longitudinal center axis of the receiving hole; depressions formed on the front surface of the flat plate at positions between the through holes; a screw inserted in the receiving hole so as to be screwed into a screw bore of the spindle motor; and bottomed holes formed on the spindle motor respectively at positions corresponding to positions of the through holes.

According to a second aspect of the invention, a disk clamp includes: a flat plate; a receiving hole penetrating through the flat plate from the front surface of the flat plate to the back surface of the flat plate so as to receive a screw therein; depressions formed on the front surface of the flat plate on an imaginary circle defined around the longitudinal center axis of the receiving hole; and projections formed on the back surface of the flat plate respectively at positions corresponding to the positions of the depressions.

The disk clamp is mounted on the rotor of the spindle motor, for example, in the same manner as described above. A screw is inserted in the receiving hole when the disk clamp is mounted. The screw is screwed into the rotor. A disk medium is in this manner mounted on the spindle motor. In the process of screwing, a jig is received in the depression, for example. The projections are formed on the back surface of the flat plate at positions corresponding to the positions of the depressions, respectively. When the jig is received in the depression, the corresponding projection is received in the bottomed hole of the rotor formed thereunder, for example. In this manner, relative rotation is restricted between the disk clamp and the rotor. The screw is thus readily screwed into the rotor.

The depressions are formed on the flat plate of the disk clamp. The projections are formed on the back surface of the flat plate at positions corresponding to the positions of the depressions, respectively. A reduction of the thickness of the flat plate is thus prevented. The thickness of the flat plate at the areas including the depressions is set equal to the thickness of the flat plate at the positions off the areas including the depressions, for example. A reduction of the rigidity of the flat plate is in this manner prevented at the areas including the depressions. Unevenness of the rigidity is thus reliably prevented around the longitudinal center axis of the receiving hole. Undulation is prevented in the flat plate.

The disk clamp is incorporated in a disk device, for example. The disk device comprises: a spindle motor; a disk medium mounted on the spindle motor at a position aligned with the rotation axis of the spindle motor; a disk clamp clamping the disk medium against the spindle motor; a receiving hole penetrating through a flat plate of the disk clamp from the front surface of the flat plate to the back surface of the flat plate, the receiving hole aligned with the rotation axis of the spindle motor; depressions formed on the front surface of the flat plate on an imaginary circle defined around the longitudinal center axis of the receiving hole; projections formed on the back surface respectively at positions corresponding to the positions of the depressions; and bottomed holes formed on the spindle motor to receive the projections.

The objects and advantages of the invention will be realized and attained by means of the elements and combinations particularly pointed out in the claims. It is to be understood that both the foregoing general description and the following detailed description are exemplary and explanatory only and are not restrictive of the invention, as claimed.

### BRIEF DESCRIPTION OF THE DRAWINGS

FIG. 1 is a plan view schematically illustrating the structure of a hard disk drive, HDD, as a specific example of a disk device according to the present invention;

FIG. 2 is an enlarged partial sectional view taken along the line 2-2 in FIG. 1, for schematically illustrating a spindle motor;

FIG. 3 is a perspective view schematically illustrating a disk clamp according to a first embodiment of the present invention;

FIG. 4 is an enlarged partial sectional view schematically illustrating the spindle motor;

FIG. 5 is an enlarged partial sectional view schematically illustrating the process of mounting a disk medium on the spindle motor;

FIG. 6 is a perspective view schematically illustrating a disk clamp according to a second embodiment of the present invention;

FIG. 7 is a perspective view schematically illustrating a disk clamp according to a third embodiment of the present invention;

FIG. 8 is an enlarged partial sectional view schematically illustrating the spindle motor; and

FIG. 9 is an enlarged partial sectional view schematically illustrating the process of mounting a disk medium on the spindle motor.

### DESCRIPTION OF EMBODIMENTS

Preferred embodiments of the invention will be explained below with reference to the accompanying drawings.

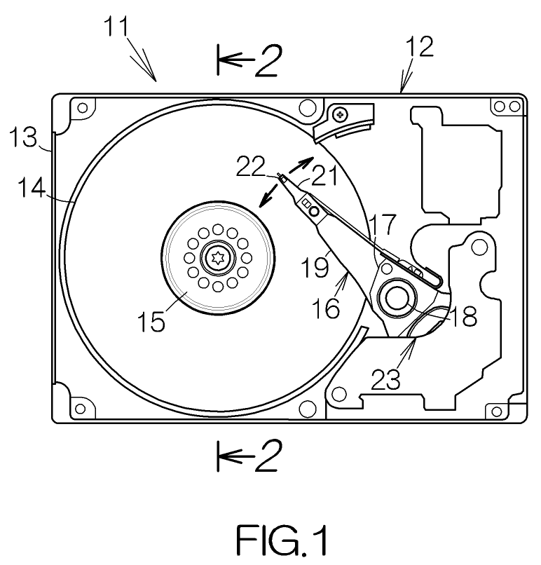

FIG. 1 schematically illustrates the structure of a hard disk drive, HDD, 11 as an example of a disk device. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. A closed space is in this manner defined between the base 13 and the cover. Pressing process may be employed to form the cover out of a plate material, for example.

At least one magnetic recording disk 14 as a disk medium is enclosed in the enclosure 12. The magnetic recording disk 14 has a diameter of 2.5 inches, for example. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 extend in the horizontal direction from the vertical support shaft 18. The carriage block 17 may be made of aluminum, for example. Extrusion molding process may be employed to form the carriage block 17, for example.

A head suspension 21 is fixed to the tip end of the individual carriage arm 19. The head suspension 21 extends forward from the tip end of the carriage arm 19. A flying head slider 22 is fixed to the tip end of the head suspension 21. A head element or electromagnetic transducer, not shown, is mounted on the flying head slider 22.

When the magnetic recording disk 14 rotates, the flying head slider 22 is allowed to receive airflow generated along the rotating magnetic recording disk 14. The airflow serves to generate a positive pressure or a lift as well as a negative pressure on the flying head slider 22. The lift is balanced with the urging force of the head suspension 21 and the negative pressure so that the flying head slider 22 is allowed to keep flying above the surface of the magnetic recording disk 14 during the rotation of the magnetic recording disk 14 at a relatively high stability.

When the carriage 16 is driven to swing about the vertical support shaft 18 during the flight of the flying head slider 22, the flying head slider 22 is allowed to move along the radial direction of the magnetic recording disk 14. This radial movement allows the electromagnetic transducer on the flying head slider 22 to cross the data zone between the innermost recording track and the outermost recording track. The electromagnetic transducer on the flying head slider 22 can thus be positioned right above a target recording track on the magnetic recording disk 14.

A power source such as a voice coil motor, VCM, 23 is connected to the carriage block 17. The voice coil motor 23 serves to drive the carriage block 17 around the vertical support shaft 18. The rotation of the carriage block 17 allows the carriage arms 19 and the head suspensions 21 to swing.

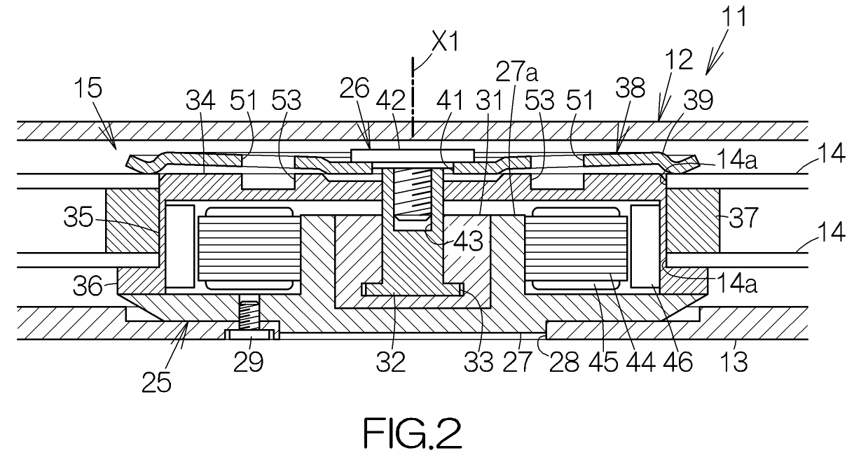

Next, a detailed description will be made on the spindle motor 15 according to an embodiment of the present invention. As shown in FIG. 2, the spindle motor 15 includes a stator 25. A rotor 26 is supported on the stator 25 for relative rotation. The stator 25 includes a bracket 27 received on the base 13. The bracket 27 is received in a receiving bore 28 formed in the bottom plate of the base 13. The bracket 27 includes a cylindrical portion 27a standing upright in the vertical direction. A screw 29 is utilized to fix the bracket 27 to the base 13, for example. An aluminum shape is shaped into the bracket 27 by scraping, for example. Alternatively, extrusion molding process may be employed to form the bracket 27, for example.

The stator 25 includes a cylindrical sleeve 31 received in the cylindrical portion 27a. The sleeve 31 is made of a metallic material such as brass, stainless steel, or the like. A vertical shaft 32 is received in a columnar space defined in the sleeve 31. A space between the sleeve 31 and the vertical shaft 32 is filled with a fluid such as a lubricant, for example. The fluid enables the vertical shaft 32 to rotate around a longitudinal axis of the vertical shaft 32, namely a rotation axis X1, at a high revolution speed. A so-called fluid bearing is established. A thrust flange 33 is attached to the lower end of the vertical shaft 32. The thrust flange 33 extends outward in the radial direction from the rotation axis X1. The vertical shaft 32 and the thrust flange 33 are made of a metallic material such as stainless steel, for example.

The rotor 26 includes a spindle hub 34 mounted on the vertical shaft 32. The spindle hub 34 defines a cylindrical body 35 defining a columnar space therein. A flange 36 is connected to one end or the lower end of the cylindrical body 35. The flange 36 extends outward in the radial direction from the cylindrical body 35. Two of the magnetic recording disks 14 are mounted on the spindle hub 34, for example. A through hole 14a is formed in the individual magnetic recording disk 14 at the center of the magnetic recording disk 14. The cylindrical body 35 of the spindle hub 34 is received in the through hole 14a. An annular spacer 37 is interposed between the magnetic recording disks 14. The annular spacer 37 serves to maintain an interval between the magnetic recording disks 14.

A disk clamp 38 is coupled to the upper end of the spindle hub 34. The magnetic recording disks 14 and the annular spacer 37 are interposed between the disk clamp 38 and the flange 36. The disk clamp 38 includes a disk-shaped flat plate 39. The flat plate 39 is made of a metallic material such as aluminum, stainless steel, or the like. A receiving hole 41 defining a disk-shaped space is formed in the flat plate 39 at the center of the flat plate 39. The receiving hole 41 penetrates through the flat plate 39 from the front surface to the back surface of the flat plate 39. The longitudinal center axis of the columnar space of the receiving hole 41 coincides with the rotation axis X1.

The screw stem of a screw 42 is inserted in the receiving hole 41. The screw stem has an external thread. The screw head of the screw 42 is received on the front surface of the flat plate 39. The screw 42 is screwed into a screw bore 43 formed in the vertical shaft 32 along the rotation axis X1. The screw bore 43 has a female thread. An urging force is applied to the magnetic recording disks 14 from the annular outer periphery 39a of the flat plate 39. The magnetic recording disks 14 are thus urged against the flange 36. A predetermined gap is kept between the back surface of the flat plate 39 and the top surface of the spindle hub 34 at the position off the outer periphery 39a.

The stator 25 includes a stator stator core 44 fixed to the outer peripheral surface of the cylindrical portion 27a. A coil 45 is wound around the stator core 44 so as to provide an electromagnet. Metallic thin films are layered on one another so as to form the stator core 44. The inner peripheral surface of the spindle hub 34 is opposed to the outer peripheral surface of the cylindrical portion 27a. Permanent magnets 46 are fixed to the inner peripheral surface of the spindle hub 34. The permanent magnet 46 is opposed to the coil 45. A magnetic field is generated in the coil 45 in response to supply of electric current to the coil 45. The magnetic field allows the spindle hub 34 to rotate around the rotation axis X1.

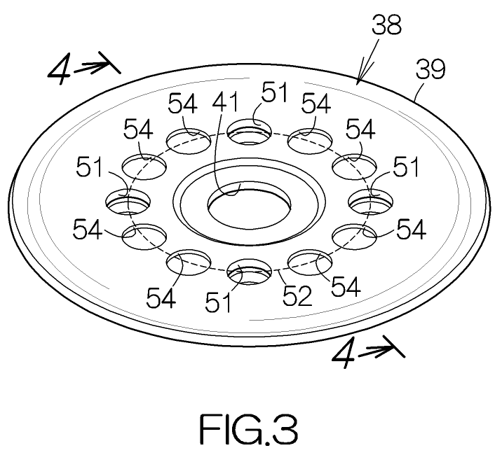

FIG. 3 schematically illustrates a disk clamp 38 according to a first embodiment of the present invention. Referring also to FIG. 3, four through holes 51 are formed in the flat plate 39 of the disk clamp 38, for example. The through holes 51 penetrate through the flat plate 39 from the front surface to the back surface of the flat plate 39. The individual through hole 51 defines a disk-shaped space, for example. The through holes 51 are arranged at equal intervals on an imaginary circle 52 defined around the longitudinal center axis of the receiving hole 41. The longitudinal center axes of the columnar spaces of the through holes 51 are set on the imaginary circle 52. Bottomed holes 53 are formed in the top surface of the spindle hub 34 at positions corresponding to the positions of their respective through holes 51. The individual bottomed hole 53 defines a disk-shaped space, for example. The longitudinal center axes of the through holes 51 coincide with those of the columnar spaces of the bottomed holes 53, respectively, for example. The inner diameter of the through holes 51 is set equal to that of the bottomed hole 53.

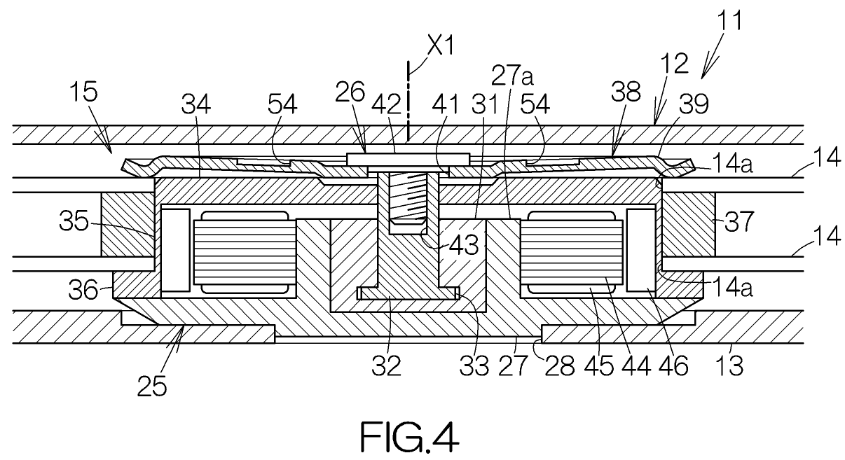

Depressions 54 are formed on the front surface of the flat plate 39 on the imaginary circle 52. Each set of the depressions 54, including two of the depressions 54, is formed in an intermediate area defined between the adjacent ones of the through holes 51. Here, all the through holes 51 and the depressions 54 are spaced from one another at equal intervals. The individual depression 54 defines a disk-shaped space, for example. The longitudinal center axes of the depressions 54 are set on the imaginary circle 52. Here, the inner diameter of the depressions 54 is set equal to that of the through holes 51. The flat plate 39 has a constant thickness, as shown in FIG. 4. The thickness of the flat plate 39 is set in a range between 0.3 mm and 0.5 mm approximately, for example. It should be noted that the thickness of the flat plate 39 at the depressions 54 is set smaller than the thickness of the flat plate 39 outside the depressions 54 by an amount equivalent to the depth of the depressions 54. Punching process is employed to form the depressions 54, for example.

Now, assume the process of mounting the magnetic recording disks 14 on the spindle motor 15. The spindle motor 15 is first assembled. The lower one of the magnetic recording disks 14, the annular spacer 37 and the upper one of the magnetic recording disks 14 are in this sequence mounted on the cylindrical body 35 of the spindle hub 34. The cylindrical body 35 penetrates the through holes 14a of the magnetic recording disks 14. The lower one of the magnetic recording disks 14 is received on the flange 36. The disk clamp 38 is then set on the spindle hub 34. The longitudinal center axes of the through holes 51 of the flat plate 39 are aligned with those of the corresponding bottomed holes 53. The outer periphery 39a of the flat plate 39 is received on the surface of the upper one of the magnetic recording disks 14.

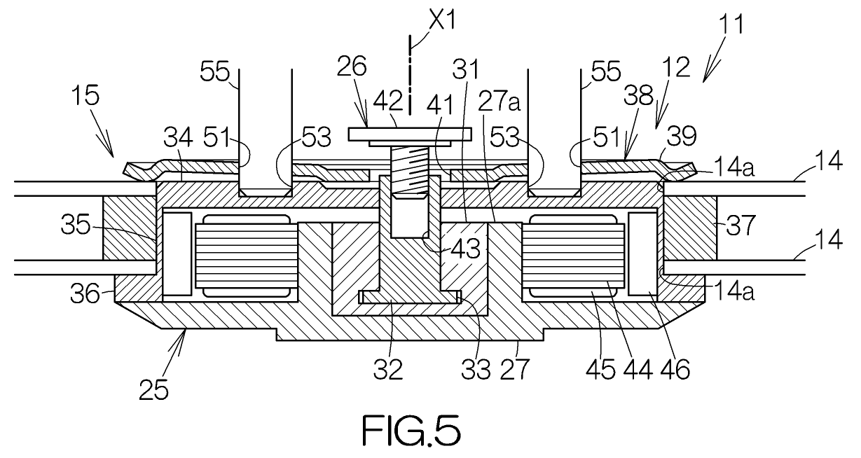

As shown in FIG. 5, jigs, namely pins 55, are inserted into the bottomed holes 53. The pins 55 pass through the corresponding through holes 51. The pins 55 are selectively inserted in a pair of through holes 51 arranged on a diameter of the flat plate 39, for example. When the pins 55 are received in the bottomed holes 53, relative rotation is prevented between the disk clamp 38 and the rotor 26 of the spindle motor 15. Simultaneously, the rotor 26 is prevented from rotation. The screw 42 is then screwed into the screw bore 43 of the vertical shaft 32 through the receiving hole 41 of the disk clamp 38. The screw head of the screw 42 is urged against the flat plate 39 toward the top surface of the spindle hub 34. In this manner, an urging force is applied to the magnetic recording disks 14 from the outer periphery 39a of the flat plate 39.

The through holes 51 are formed in the flat plate 39 of the disk clamp 38. The through holes 51 are arranged on diameters of the flat plate 39. The through holes 51 are arranged at equal intervals around the longitudinal center axis of the receiving hole 41. The rigidity of the flat plate 39 is reduced at the areas including the through holes 51. Simultaneously, the depressions 54 are formed in an intermediate area defined between the adjacent ones of the through holes 51. The thickness of the flat plate 39 is reduced at the areas including the depressions 54. The rigidity of the flat plate 39 is thus reduced at the intermediate areas. In this manner, unevenness of the rigidity is eliminated around the longitudinal center axis of the receiving hole 41. Undulation is thus reduced on the flat plate 39 along the imaginary circle 52. An urging force is uniformly applied to the magnetic recording disk 14 along the outer periphery of the disk clamp 38. The magnetic recording disk or disks 14 are thus prevented from suffering from undulation to the utmost.

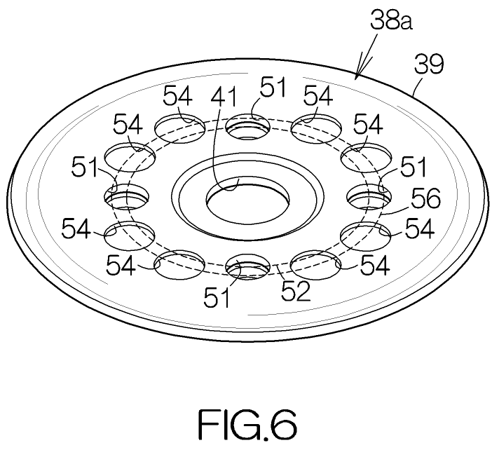

FIG. 6 schematically illustrates a disk clamp 38a according to a second embodiment of the present invention. The aforementioned depressions 54 are arranged on an imaginary circle 56 defined around the longitudinal center axis of the receiving hole 41 in the disk clamp 38a. The imaginary circle 56 has the center aligned with the longitudinal center axis of the receiving hole 41. The diameter of the imaginary circle 56 is set larger than that of the imaginary circle 52. In other words, the longitudinal center axes of the depressions 54 are set at positions between the imaginary circle 52 and the outer periphery of the disk clamp 38a. The inner diameter of the depressions 54 is set larger than that of the through holes 51. The thickness of the flat plate 39 at the areas including the depressions 54 is smaller than the thickness of the flat plate 39 at the positions off the depressions 54 by an amount equivalent to the depth of the depressions 54 in the same manner as described above. Like reference numerals are attached to the structure or components equivalent to those of the disk clamp 38 according to the first embodiment.

In the disk clamp 38a, the through holes 51 are formed in the flat plate 39 in the same manner as described above. The through holes 51 are arranged at equal intervals on the imaginary circle 52 around the longitudinal center axis of the receiving hole 41. The rigidity of the flat plate 39 is reduced at the areas including the through holes 51. Simultaneously, the depressions 54 are formed in an intermediate area defined between the adjacent ones of the through holes 51. The longitudinal center axes of the depressions 54 are located outside the imaginary circle 52. The depressions 54 have the longitudinal center axis outside the imaginary circle 52. This enables the depressions 54 having the inner diameter set larger than that of the through holes 51. The rigidity of the flat plate 39 is reduced at the intermediate areas because of formation of the depressions 54. Unevenness of the rigidity is eliminated around the longitudinal center axis of the receiving hole 41. Undulation of the flat plate 39 is reduced along the imaginary circle 52. An urging force is uniformly applied to the magnetic recording disk 14 along the outer periphery of the disk clamp 38a. The magnetic recording disk or disks 14 are thus prevented from suffering from undulation to the utmost.

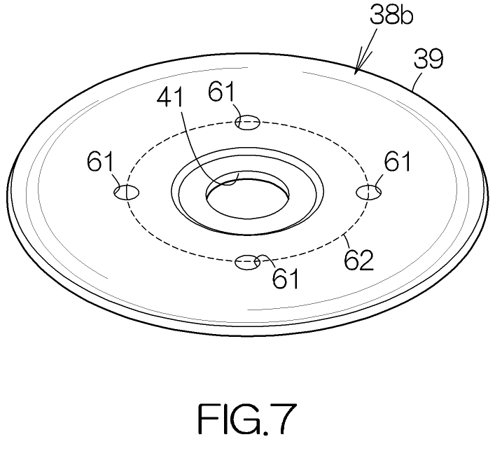

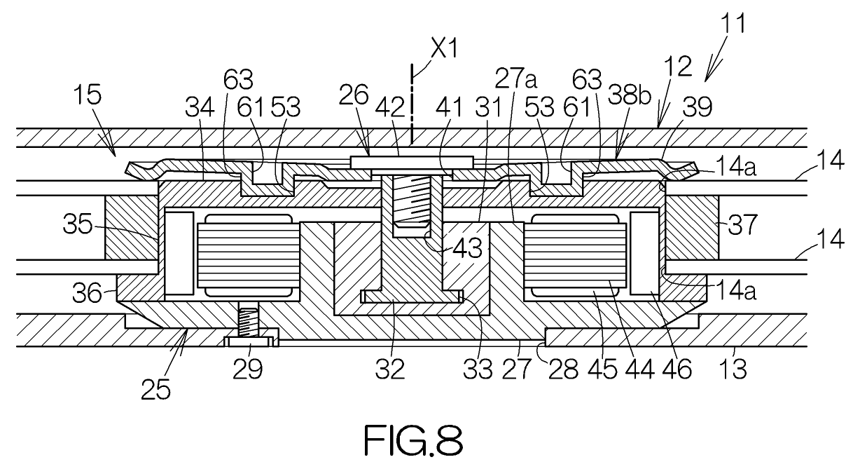

FIG. 7 schematically illustrates a disk clamp 38b according to a third embodiment of the present invention. Depressions 61 are formed in the flat plate 39 in place of the aforementioned through holes 51 in the click clamp 38b. The aforementioned depressions 54 are omitted. The depressions 61 are arranged at equal intervals on an imaginary circle 62 defined around the longitudinal center axis of the receiving hole 41. The imaginary circle 62 has the center aligned with the longitudinal center axis of the receiving hole 41. Referring also to FIG. 8, the thickness of the flat plate 39 at the areas including the depressions 61 is set equal to the thickness of the flat plate 39 at the positions off the depressions 61. Projections 63 are thus formed on the back surface of the flat plate 39 at positions corresponding to the positions of the depressions 61, respectively. Punching process is employed to form the depressions 61 and the projections 63, for example. The projections 63 are received in the aforementioned bottomed holes 53, respectively. Like reference numerals are attached to the structure or components equivalent to those of the aforementioned embodiments.

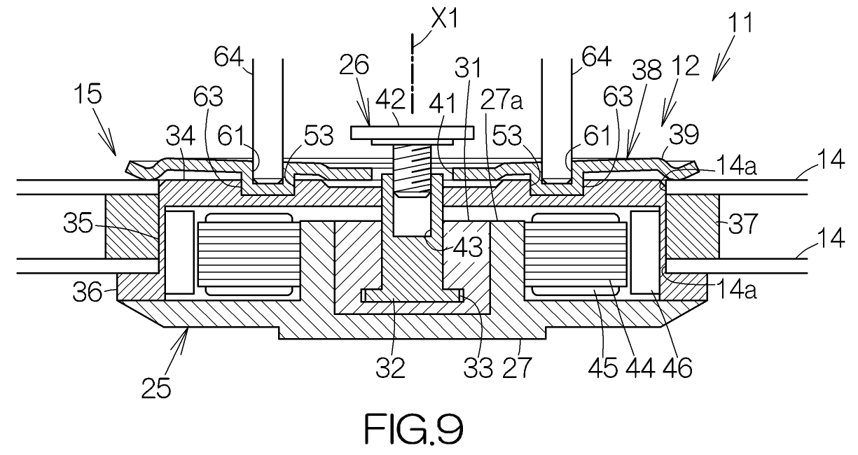

As shown in FIG. 9, when the disk clamp 38b is mounted, the projections 63 of the flat plate 39 are received in the corresponding bottomed holes 53 of the spindle hub 34, for example. Jigs, namely pins 64, are inserted in the depressions 61 arranged on a diameter of the disk clamp 38b. Simultaneously, the screw 42 is screwed into the screw bore 43 of the vertical shaft 32 through the receiving hole 41. Since the projections 63 are received in the corresponding bottomed holes 53, relative rotation is restricted between the disk clamp 38b and the rotor 26 of the spindle motor 15. The pins 64 serve to restrict the rotation of the rotor 26. When the screw 42 has been screwed into the screw bore 43, the screw head of the screw 42 is urged against the flat plate 39 toward the top surface of the spindle hub 34. In this manner, an urging force is applied to the magnetic recording disks 14 from the outer periphery 39a of the flat plate 39.

The depressions 61 are formed in the flat plate 39 of the disk clamp 38b. The depressions 61 of each pair are arranged on a diameter of the flat plate 39. The depressions 61 are arranged at equal intervals around the longitudinal center axis of the receiving hole 41. The thickness of the flat plate 39 at the areas including the depressions 61 is set equal to the thickness of the flat plate 39 at the positions off the depressions 61. A reduction in the rigidity of the flat plate 39 is prevented at the areas including the depressions 61. Unevenness of the rigidity is thus reliably prevented around the longitudinal center axis of the receiving hole 41 along the imaginary circle 62. Undulation of the flat plate 39 is prevented. An urging force is uniformly applied to the magnetic recording disk 14 along the outer periphery of the disk clamp 38b. The magnetic recording disk or disks 14 are thus prevented from suffering from undulation to the utmost.

All examples and conditional language recited herein are intended for pedagogical purposes to aid the reader in understanding the invention and concepts contributed by the inventor to furthering the art, and are to be construed as being without limitation to such specifically recited examples and conditions, nor does the organization of such examples in the specification relates to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A disk clamp comprising:
a flat plate;
a receiving hole penetrating through the flat plate from a front surface of the flat plate to a back surface of the flat plate so as to receive a screw therein;
through holes penetrating through the flat plate from the front surface of the flat plate to the back surface of the flat plate on an imaginary circle defined around a longitudinal center axis of the receiving hole; and
depressions formed on the front surface of the flat plate at positions between the through holes.

2. The disk clamp according to claim 1, wherein a diameter of the depressions is set larger than a diameter of the through holes.

3. The disk clamp according claim 1, wherein the depressions have centers located outside the imaginary circle.

4. A disk device comprising:
a spindle motor;
a disk medium mounted on the spindle motor at a position aligned with a rotation axis of the spindle motor;
a disk clamp clamping the disk medium against the spindle motor;
a receiving hole penetrating through a flat plate of the disk clamp from a front surface of the flat plate to a back surface of the flat plate, the receiving hole aligned with the rotation axis of the spindle motor;
through holes penetrating through the flat plate of the disk clamp from the front surface of the flat plate to the back surface of the flat plate on an imaginary circle defined around a longitudinal center axis of the receiving hole;
depressions formed on the front surface of the flat plate at positions between the through holes;
a screw inserted in the receiving hole so as to be screwed into a screw bore of the spindle motor; and
bottomed holes formed on the spindle motor respectively at positions corresponding to positions of the through holes.

5. The disk device according to claim 4, wherein a diameter of the depressions is set larger than a diameter of the through holes.

6. The disk device according to claim 4, wherein the depressions have centers located outside the imaginary circle.

7. A disk clamp comprising:
a flat plate;
a receiving hole penetrating through the flat plate from a front surface of the flat plate to a back surface of the flat plate so as to receive a screw therein;
depressions formed on the front surface of the flat plate on an imaginary circle defined around a longitudinal center axis of the receiving hole; and
projections formed on the back surface of the flat plate respectively at positions corresponding to positions of the depressions.

8. A disk device comprising:
a spindle motor;
a disk medium mounted on the spindle motor at a position aligned with a rotation axis of the spindle motor;
a disk clamp clamping the disk medium against the spindle motor;
a receiving hole penetrating through a flat plate of the disk clamp from a front surface of the flat plate to a back surface of the flat plate, the receiving hole aligned with the rotation axis of the spindle motor;
depressions formed on the front surface of the flat plate on an imaginary circle defined around a longitudinal center axis of the receiving hole;
projections formed on the back surface respectively at positions corresponding to positions of the depressions; and
bottomed holes formed on the spindle motor to receive the projections.
